(19) United States
(12) Patent Application Publication
(10) Pub. No.: US 2016/0311697 A1
(43) Pub. Date: Oct. 27, 2016

(54) MATERIALS AND METHODS FOR LIQUID WASTE CAPTURE

(71) Applicant: SOLID FLUIDS & TECHNOLOGIES CORP., Calgary (CA)

(72) Inventor: TERRY W. HOSKINS, Calgary (CA)

(21) Appl. No.: 15/139,526

(22) Filed: Apr. 27, 2016

Related U.S. Application Data
(60) Provisional application No. 62/153,117, filed on Apr. 27, 2015.

(51) Int. Cl. C02F 1/28; B01J 20/22; C09K 8/34; C09K 3/32; C08J 9/22; C09K 8/28; B01J 20/26; B01J 20/28

(52) U.S. Cl. CPC C02F 1/285; B01J 20/261; B01J 20/22; B01J 20/28016; C09K 3/32; C08J 9/22; C09K 8/28; C09K 8/34; C08J 2325/06; C02F 2101/32

(57) ABSTRACT

A method for capturing waste liquid from waste liquid-containing material, the method includes: combining expanded polystyrene particles that have cut surfaces with the material, to thereby form a mixture wherein at least some of the waste liquid from the material is captured by the expanded polystyrene particles.

### FIELD

The invention relates to liquid waste capture such as capturing hydrocarbon from spills or capturing petroleum operation liquid waste such as drilling fluids.

### BACKGROUND

It is often desirable to capture liquid hydrocarbons to prevent their infiltration to an environment. For example, it is desirable to capture liquid hydrocarbons such as oil after spills on water or soil.

Also, in the process of drilling a well into underground formations “drill cuttings” are produced in large quantities from the earthen and rock materials that have been excavated out of the well bore. The earthen formations that are drilled produce a stream of broken rock particles, of all sizes, that is carried from the bottom of the developing well bore by a drilling fluid. The rock particles are separated from the drilling fluid upon the return of fluid system circulation, back at surface, by various mechanical means. These solid waste excavations removed from a well bore, once separated, are generally referred to in the bore hole drilling industry as “cuttings”.

Generally the developed cuttings and other materials sloughing into the well bore, produced while drilling wells in the ground, have been exposed to and saturated by drilling fluids that can contain various salts, chemicals, and or hydrocarbons and as such create a difficult to process and dispose of waste stream. Various regulations from industry, federal, and provincial governments apply to the safe disposal of cuttings produced while drilling wells. Drilling fluids can be water-based such as including brines, created from hydrocarbons, such as a pure refined oil or can be blends or emulsions of water & oil types at various percentages with the hydrocarbon generally being the primary phase; such as in a chemical invert emulsion drilling fluid.

Cuttings that have been exposed to drilled hydrocarbons zones or hydrocarbon based drilling fluids that retain a percentage of hydrocarbons greater than 1% for example, up to 30% (often 5 to 25%) and/or have been exposed to high levels of salts, silicates or other hazardous chemicals, are required to be transported to an industry and government approved oilfield waste landfill facility for proper waste containment and disposal. Generally, the created cuttings have been exposed to a liquid drilling fluid which can be either water or hydrocarbon based and the cuttings are considered to be liquid wetted. They contain rock particles and interstitial liquids including the drilling fluid and formation fluids (i.e. oil, brine, etc.) and may be wet and sloppy in structure.

Industry and government regulations prevent the disposal of liquid wastes to approved landfill facilities and, as such, “the wet or unstable cuttings” must be stabilized prior to transport to an approved waste facility. Industry and government regulations clearly dictate to what extent cuttings must be stabilized and provide data from an industry accepted test referred to as the “Paint Filter Test” (see Example #4) to determine if cuttings are suitable for transport and disposal at approved landfills. While cuttings stabilization is determined by government regulation, stabilized cuttings are considered as having substantially no free water, such that no water drains from the cuttings when they are left to drain.

Section 15.8 within EUB Guide 58 also states that the disposal of liquid oilfield waste into any landfill class is prohibited. Therefore, any oilfield waste received at any class I, II or III landfill must be solid. Generators should also note that the mixing of oilfield waste with any solid for the primary purpose of dilution to avoid any Alberta regulatory requirement is in direct contravention of Section 5.5 of EUB Guide 58. Therefore, oilfield wastes intended for direct landfilling must pass the paint filter test (i.e. be classified as a solid) prior to the addition of any amendments. Provided the material passes the above test, the subsequent addition of sorbent material required to facilitate solids handling and to manage any interstitial liquids that could shake out during the transportation of these wastes to the landfill is acceptable.

Currently several methods are utilized to stabilize oilfield waste cuttings for road transport and disposal. Adding additional dry solids to absorb/adsorb excess fluids is common. One such method is to use kiln dried bulk sawdust or wood chips that can be blended in with the waste cuttings by mechanical means in storage bins prior to transport. Dried sawdust can absorb some free oil from hydrocarbon contaminated cuttings to stabilize them enough for transport and disposal at landfill.

Sawdust does however have several negative effects on the waste stream of cuttings. Sawdust must be kiln dried to be effective then transported to site in large volumes at a high cost. Sawdust when exposed to the elements, while stored on site, can adsorb water from rain or snow which limits the ability to adsorb free oil from hydrocarbon cuttings. Additionally when sawdust is added to the waste cuttings the total disposal volume and bulk weight of the cuttings that needs to be transported and disposed of increases by the weight and volume of the sawdust addition. As the cuttings require transport by truck on provincial roadways, they are subject to regulated weight restrictions, so more trucking loads will be required after sawdust additions to the cuttings volume. Landfill disposal is based on an overall weights of solids deposited into the landfill; any additional weight added to the disposal stream adds costs to the overall disposal costs and transportation costs for a well bore drilling operation.

While some other material have been used in an attempt to stabilize cuttings, these materials also create many of the same cost concerns including; high cost of the material, additional weight added from the material, increased volumes after blending into the waste cuttings, and creating additional weight and volume into the transportation of the waste stream. Some materials that have been tried to stabilize waste cuttings include; sawdust, various cellulose plant fibers, oil soluble thickeners, waste rubber crumbs, various polymers, adsorbent clay materials, amine treated clay materials, fly ash, pozzolans, cements, and or zeolite type materials.

It is therefore desirable to offer a material that overcomes one or more of the aforementioned problems when applied to capture liquid hydrocarbons from an environment.

Some drilling operations choose to drill some formations with brine fluids, such as for example, high density brine fluids, to potentially increase the rate of penetration (ROP) while drilling. These fluids produce cuttings that must be shipped to a properly licenced landfill facility due to their saturation with various salts and salt mixtures. These cuttings are again subject to stabilization under transportation rules. These cuttings can be difficult to stabilize with sawdust and require larger volumes of sawdust as the cellulose fibre structure of the sawdust will not absorb the brines as easily as fresh water. Stabilization with sawdust in these cases again comes with the same undesirable effects of utilizing sawdust to stabilize waste cuttings in general such as a problematic increase in volume and total weight.

### SUMMARY

In accordance with a broad aspect of the present invention, there is provided expanded polystyrene (EPS) particles for use as a capturing material to capture liquid waste from an environment, the EPS particles being cut from whole particles such that there are cut surfaces exposed on the EPS particles.

In accordance with a broad aspect of the present invention, there is provided landfill-ready liquid waste-contaminated material comprising: expanded polystyrene (EPS) particles having cut surfaces to expose opened bubbles, wherein the liquid waste is captured by the expanded polystyrene particles.

In accordance with another broad aspect, there is provided a method for capturing liquid waste from liquid waste-containing material, the method comprising: combining expanded polystyrene particles with the material, the expanded polystyrene particles having cut from whole particles such that there are cut surfaces exposed on the EPS particles with the material, to thereby form a mixture wherein at least some of the liquid waste from the material is captured by the expanded polystyrene particles.

The liquid waste is captured by adsorption, absorption or retention as an interstitial fluid.

The environment and the materials to be treated may be water, soil or waste materials, such as drilling fluid or drill cuttings. Environment, as used herein, may be a site such as an area effected by a hydrocarbon spill and/or may include an amount of waste such as drill cuttings.

Due to the very low weight of EPS, the EPS particles may add little to the overall weight of the captured hydrocarbon, as may be important with respect to disposal of materials.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### BRIEF DESCRIPTION OF THE DRAWINGS

Referring to the drawings, several aspects of the present invention are illustrated by way of example, and not by way of limitation, in detail in the figures, wherein:

FIG. 1 shows a schematic illustration of a method according to the present invention.

### DETAILED DESCRIPTION OF VARIOUS EMBODIMENTS

The detailed description set forth below is intended as a description of the present invention and is not intended to represent the only embodiments contemplated by the inventor. The detailed description includes specific details for the purposes of providing a comprehensive understanding of the present invention. However, it will be apparent to those skilled in the art that the present invention may be practiced without these specific details.

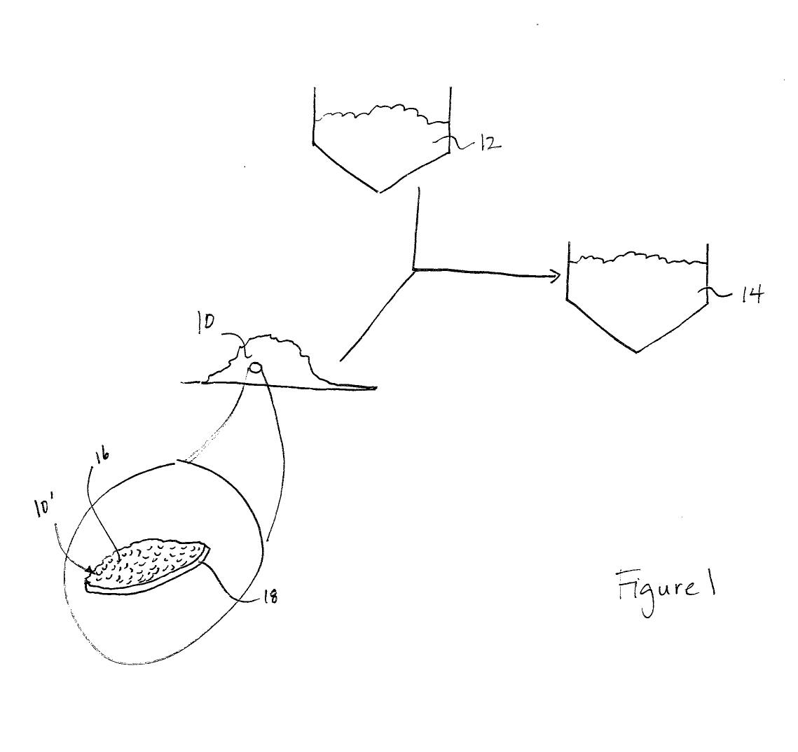

The invention uses expanded polystyrene (EPS) particles as a capturing material, for example, to capture liquid waste from an environment. Liquid waste such as liquid hydrocarbon or brine may be adsorbed, absorbed and/or retained by the EPS particles. As such, with reference to FIG. 1, when the EPS particles 10 are mixed with a material 12, liquid waste in the material is captured by particles 10, as by adsorption, and possibly by interstitial retention or absorption. A resultant mixture 14 is formed which includes EPS particles and liquid waste.

Considering an environment including material such as soil or water, capturing spilled liquid hydrocarbon may offer remediation. Considering an environment such as oil field waste such as an amount of tank bottoms or an amount of oilfield cuttings, capturing hydrocarbon or brine may stabilize oilfield cuttings or sludge waste.

Expanded polystyrene (EPS) particles 10 that are useful are those that are cut. FIG. 1 shows an EPS particle 10′ in the form of a flake which has a cut surface 16. Surface 16 is formed by cutting through the outer surface skin 18 of a larger EPS structure so that the internal bubble structure (illustrated on surface 16) is exposed on at least some of the particle surfaces. When a whole particle is cut, skin 18 on the surface of the EPS is broken open to expose some of the bubbles that are present within a whole EPS particle. The EPS materials are created from styrene, a hydrocarbon material. As such, the EPS particles alone blend easily with a hydrocarbon without an additional chemical requirement. The EPS particles may blend with a water-based liquid by addition of a surfactant to the mixture.

The EPS particles may be less than 5 mm. For example, less than 1 mm. The particles may be shaped as with similar dimensions on all axis or with longer dimensions in some axis and shorter dimensions in other axis such that the particles resemble flakes. The flake can be of any size or dimension so as to increase the surface area of a given amount of EPS flakes. In one embodiment, the particles are flake-shape with a width or length of the flake from 500 microns to 3000 microns and a thickness of 1-3000 microns, such as 100-1000 microns or 50-500 microns.

The EPS particles may be used in an amount sufficient to adsorb a desired percentage of the waste liquid to be captured. It is to be noted that (1) the waste liquid may be present in an environment at various concentrations and (2) how much of the waste liquid is to be captured may vary from operation to operation. However, generally the EPS particles are used in volume ratios of 6:1 to 1:2 (volume of material to be treated : volume of EPS particles). The variance depends on the actual waste liquid content in the material to be treated, for example the actual liquid waste content in contaminated soil or used drill cuttings. For example, in one embodiment of hydrocarbon drill cuttings, EPS has also been found to provide excellent results when combined with drilling cuttings having a 10-20% liquid content at a 2:1 to 4:1 ratio (volume of material to be treated:volume of EPS particles).

Because EPS has such a low weight, regardless of the volumes used, the weight is likely to be much less than the weight of the material to be treated. For example, generally, EPS has a density of 8 kg/m³ and can be obtained readily with a moisture content of 0%. This can be compared to sawdust, which has a density of 270 kg/m³ and 10-30% moisture. If it is desired to increase the density of EPS, it can be compressed but even then the density will be well below the density of sawdust.

Cut EPS particles may be obtained from grinding, flaking, cutting, shaving, etc. whole particles, such as individual whole particles or larger formed EPS materials. These particles, herein collectively referred to as cut particles (i.e. cut, shaved, ground and/or flaked), may be produced from a recycling volume reduction grinder or an EPS foam block CNC lathe or router. Cut particles are an ideal material to capture waste liquids such as brine drilling fluids, hydrocarbon from an environment such as to stabilize cuttings waste that has been brine or hydrocarbon exposed from drilling hydrocarbon zones or hydrocarbon-based drilling fluids.

Cutting the EPS particles increases the surface area over uncut particles and due to the EPS structure of internal closed cell air chambers (which are effectively gas bubbles), cutting may expose opened air bubbles on the cut surfaces, thereby further increasing the surface area for liquid adsorption.

For example, EPS materials in any form such as beads, blocks, forms, slabs, etc. contain a plurality of closed cell air bubbles in their internal structure to create the low density foam expansion material. Cut EPS materials, such as created by a CNC cutting process such as a milling or routering process or a proper mechanical size reduction cutting mill, are small in size with a large surface area and further have at least some and possibly many of their internal air bubbles opened as by cutting or shaving during the mechanical processing. After cutting, the liquid waste can be adsorbed into the internal structure of the open cells as well as through the high surface area of exposure on the small flakes or cuts.

The cut EPS particles can be employed in suitable amounts such that the exposed surface area and resultant opened internal air cells are sufficient enough to take on the liquid by adsorption onto the particle surface or interstitially between particles and possibly by some swelling due to polystyrene softening. Capturing the free fluids from soil or water surfaces may thereby remediate them. Capturing the free fluids from tank bottoms, waste cuttings or other sludges may thereby substantially dry and stabilize them, to facilitate disposal.

EPS cut particles add almost no bulk density to the waste volume. These materials do not increase the overall waste volume by much, are not considered hazardous, and are readily available. EPS cut particles, especially from EPS recycle and EPS waste cuts are relatively low cost materials.

EPS materials are useful to capture hydrocarbon liquids from hydrocarbon-containing materials such as water, soil or petroleum waste such as drill cuttings. EPS particles can stabilize waste cuttings as they have the ability to adsorb easily onto to their surfaces hydrocarbon fluids, even without additional chemical requirements. The EPS particles adsorb the interstitial or free hydrocarbon fluids from hydrocarbon-exposed waste cuttings.

EPS particles can be also utilized to stabilize water-based cuttings where a partial emulsion or some percentage of hydrocarbon is emulsified within a water based drilling fluid. An example of such a cuttings waste would be generated from a water-based drilling fluid utilized to drill a hydrocarbon producing formation where, as such, the drilling fluid can be contaminated or can include a portion of the hydrocarbon being drilled so that a hydrocarbon becomes emulsified with the water on the generated waste cuttings. This may occur, for example, when a water-based drilling fluid is employed to drill a heavy oil formation or a SAGD (Steam Assist Gravity Drainage) drilling fluid.

Cuttings may be stabilized by addition of EPS particles, where a hydrocarbon is present in the form of an emulsion in any percentage from low to high whether created by mechanical means or chemical emulsion where the hydrocarbon is blended with the water based drilling fluid by intentional addition or via formation hydrocarbon contamination of the drilling fluid. It is believed that the presence of the emulsion-forming hydrocarbon allows the EPS flake or material to adsorb the interstitial fluids on the cutting due to the oleophilic nature of the EPS flakes.

The addition of surfactants may facilitate further liquid capture. In particular, the EPS materials can adsorb water onto its surface area by adding a surfactant to the water, even where the water contains no hydrocarbon. For example, any water wetting surfactants may be useful including a non-ionic surface wetting agent such as SuperWet 250™, which is a blend of ethoxylated surfactants including: 1,2 Ethanediol (Ethylene Glycol) CAS No. 107-21-1 (Concentration 60-100% by vol); and Poly(oxy-1,2-ethanediyl), alpha, alpha'-[1,4-dimethyl-1,4-bis(2-methylpropyl)-2-butyne-1,4-diyl]bis[omega-hydroxy]—CAS No. 9014-85-1 (Concentration 10-30% by volume).

As such, the EPS materials can also be used to stabilize water-based cuttings, where a surfactant is used.

Water-based cuttings can be stabilized such as those derived from drilling with water based drilling fluids such as various brine fluids, high density mixtures of salts to create high density brines, formation brines, and or various inhibited water based fluids such as silicate fluids.

It should be noted that the water wetting agent can be added to the water based drilling fluid before cuttings generation while drilling, to the recovered cuttings after drilling, and or to the EPS materials (onto their surface or into the material) prior to the mixing process or during the mixing process, providing the desired chemical affect to allow the EPS materials to adsorb the free interstitial water present in the waste cuttings.

EPS materials used to stabilize petroleum waste including drilling fluids and waste sludges such as cuttings may provide substantial cost savings to oilfield operators. EPS materials add very little to the waste disposal weight with only a small effect on the disposal volume, this translates to savings on transport and disposal costs. Less waste in terms of volume and weight will need to be transported by truck and disposed of at a volume of metric tonnage in an approved oilfield landfill facility.

The method of the invention uses EPS particles that are have cut surfaces, such as for example, flakes or granules, small high surface area flakes, fine flakes, finely ground, cut flakes, and or ground flakes from new or recycled EPS, each alone or in combination. During manufacture of the EPS cut particles, their shape and size can be adjusted accordingly to create more surface area or higher specific gravities of the resultant flakes or granules such that they are more resistant to movement by environmental forces such as wind during their usage.

EPS particles are ideal to stabilize waste cuttings produced from a well bore that has been drilled with hydrocarbon based drilling fluids or water based fluids that are exposed to hydrocarbon producing formations. EPS materials do not require any chemical additions in order blend with the hydrocarbon-containing cuttings, add almost no density to the blended volumes, and do not increase the blended volume by much.

With water wetting agents, EPS particles can be used to stabilize water based fluids even those that are substantially free of hydrocarbons.

The waste cuttings with EPS particles incorporated therein can be disposed of. The EPS particles in the waste cuttings blend also likely will not interfere with the waste recovery and recycling process through which some of the uses or landfilled hydrocarbons are recovered over time at the landfill site.

Alternately, in an alternate embodiment, the EPS particles can be recovered and processed to remove the liquid hydrocarbon therefrom. The EPS particles can then be used again for capture of hydrocarbon by, for example, incorporation into further waste cuttings.

The EPS materials may be added in any percentage or amounts in combination with other known waste cutting stabilization materials such as sawdust, various cellulose plant fibers, oil soluble thickeners, waste rubber crumbs, various polymers, adsorbent clay materials, amine treated clay materials, fly ash, pozzolans, cements, and or zeolite type materials. Desirable EPS waste materials may also include blends of cut materials or sawdust materials produced from saw cutting of engineered products such as pressboard or formed board products that have an EPS insulation sandwiched in-between two panels.

To facilitate handling and transport, the EPS materials may be shipped prior to cutting or put in totes, bound, bagged, vacuum packed, or aggregated in some way such as by pelletizing, compression or compaction such as by cold compacting. The materials may be in an untreated form or premixed with surfactant.

The very low density EPS materials can be subject to wind forces and easily blown around during and prior to mixing at the field level. EPS flakes that have been bagged can be added to the waste stream. Whole bagged EPS materials can be added into the waste materials mix tanks and buried into the cuttings volume while still bagged, then broken up and mixed together under and into the waste cuttings by mechanical means with little exposure to wind forces or open air.

Another means of transport and handling could be done through bulk silos and pneumatic transfer (i.e. by positive or negative pressure) of the materials between trucks and storage silos, and then directly applied to the environment such as for example, into the waste cuttings for mechanical mixing from onsite storage silos.

Shipping as uncut or aggregated blocks reduces loss by wind forces and permits more efficient transport since the density of the EPS can be increased.

The blocks can be shipped to a worksite, such as a facility, oil well site or spill remediation site, where they will be broken down to particles. The blocks of expanded polystyrene may be shipped to a worksite where they will be used and the blocks may be broken apart, as by cutting, adhesive solubilisation or simply handling and mixing, at that worksite to form the expanded polystyrene particles.

The EPS particles may be aggregated by mixing with adhesives that are soluble in the waste liquid to be adsorbed and forming blocks with the adhered particles. Such adhered particles become separated when in contact with the waste liquid to be adsorbed. Oil-soluble adhesive or water-soluble adhesive can be selected depending on the material to be treated.

Compaction of the EPS materials to form blocks can add to the cost effectiveness of transporting with more mass in a given transportation volume. For example, while the density of the EPS particles after cutting is normally 5-10 kg/m³ (about 8 kg/m³), compaction can readily increase the density to up to 100 kg/m³, for example to about 10 to 50 kg/m³ (about 20 kg/m³). Compaction of the EPS materials allows for the blending of the EPS with the cuttings waste to be done more effectively as the particles are added in a form with a number of particles attached together, then broken up while mechanically mixing; returning to their original low bulk density upon release of compaction or adhesion forces. Compacted materials would be easier to handle and mix at a field location.

One process of compaction of fine EPS materials that are hard to compress would be to add a spray adhesive, as described above, to the fine EPS materials before screw or mechanical compaction forces are applied to bind or adhere the particles together in a compressed block. An oil soluble adhesive would be desirable as when the materials were added to the waste hydrocarbon cutting stream; the adhesive would be quickly dissolved by the free hydrocarbons allowing the EPS to be released from the binding or compaction process and allow them to be more efficiently mixed into the waste cutting stream to stabilize the waste blend.

Another aspect of the invention is the capture of hydrocarbons from the surface of water such as in an oil or other hydrocarbon spill clean-up scenario.

EPS particles with cut surfaces can be employed to capture liquid hydrocarbon from spills on water. EPS flakes that have been cut to increase the surface area of the material to open the closed cell air bubbles, can adsorb oil into and onto its surfaces. Since the EPS materials are hydrophobic, in chemical nature, they will not easily adsorb water. The low density of EPS materials allows them to float on the water surface. The EPS flakes have an affinity for hydrocarbons and can adsorb or tie up the hydrocarbons floating on the water's surface.

EPS material could be shipped to the site of an oil spill on water in the form of a block, such as a compacted form, and can be ground or cut to shape and size on site to produce desirable flake cuts, then sprayed onto or into the area affected by a hydrocarbon spill to adsorb and bind the hydrocarbon. EPS particles, once applied onto the water surface, will float in place to come in contact with a hydrocarbon or the spilled hydrocarbon. EPS flakes used to clean up a hydrocarbon spill on water float on the surface of the water before and after contacting the hydrocarbon. When the hydrocarbons are tied up in the EPS materials, a more solidified material is created but this material still floats. This combination of EPS and hydrocarbon can be removed from the site of a spill or off the surface of the water by vacuum, mechanical skimming, or other removal systems. EPS flakes can partially solidify and act as binder with the hydrocarbon slowing the spread of the spilled hydrocarbon. EPS materials before and after hydrocarbon exposure and adsorption would remain on the surface of the water such that the hydrocarbon EPS combination could be more easily skimmed from the surface of the water.

EPS particles can be applied onto the water surface contained within a liquid penetrable container, such as a sack. The sack may be formed of mesh, netting, etc. and has apertures sized smaller than the EPS particles, such that the particles cannot pass through the apertures. However, liquid such as water and oil can pass through. Since the particles remain in the sack, this may facilitate recovery of the EPS still contained in the sacks from the water surface.

The EPS cut particles, once removed, can be processed with other hydrocarbon removal techniques such as adsorption of the hydrocarbons onto a belt filter, a transfer from one medium to another, or pressure expression, and the particles can be re-used or sprayed back onto the spill to adsorb hydrocarbons again. If a sack is used, the sack can be processed to remove the captured hydrocarbon. It should also be noted that one desirable feature of utilizing the EPS flakes in a water penetrable container is that due to the nature of the EPS material the hydrocarbons are adsorbed onto the surface area of the EPS particles and as such, the captured hydrocarbons can be removed from the EPS materials and from the sack. The oil can be recovered and EPS particles contained in the container can be re-used to recover and adsorb additional hydrocarbons.

The above-described embodiments of the invention are intended to be examples only. Alterations, modifications and variations can be effected to the particular embodiments by those of skill in the art without departing from the scope of the invention, which is defined solely by the claims appended hereto.

Exemplary embodiments of the present invention are described in the following Example, which is set forth to aid in the understanding of the invention, and should not be construed to limit in any way the scope of the invention as defined in the claims which follow thereafter.

### EXAMPLES

In the Examples, where waste EPS flakes are used, these flakes are EPS waste cut materials created from an EPS CNC lathe.

In the Examples, tests were conducted to show the EPS particles' ability to create a stabilized, more solid, waste substantially without adding more mass to the overall waste stream.

### Example #1

50 grams of waste solids that were separated from a hydrocarbon drilling fluid by centrifuge were weighed and separated to an accuracy of +/−1.0 gram. The waste solids were dark brown, very viscous and pasty, with a glossy surface.

Less than 1 gram of EPS waste flakes were weighed and separated. The EPS material was white and fluffy.

The volume of the waste solids 50 g sample was approximately the same as the volume of EPS.

The waste solid and the EPS waste flakes were blended together with some mixing movements of a flat stick in a holding cell.

The blend of materials was doughy and was brown with white flecks. The blend of materials were re-weighed to confirm blended density, which was about 50 grams. It was observed that the volume was only slightly more than the original volume of the waste solids.

The blended materials were placed on a white paper towel, spread out over the surface and left for a 30 min retention time. After 30 min, the blended materials were pushed aside on the paper towel to visually determine if there was a transfer of oil from the blended materials to the towel. The towel showed only a few brown coloured spots and it was visually confirmed that almost no oil transferred to the paper towel.

### Example #2

48 grams of waste solids that were separated from a hydrocarbon drilling fluid by a screen rig shaker were weighed and separated to an accuracy of +/−1.0 gram. The waste solids sample was dark brown and lumpy, appearing as a combination of viscous paste and solid pieces.

Less than 1 gram of EPS waste flakes were weighed and separated. The amount of waste flakes used to stabilize the waste cuttings sample was less about ½ the volume of waste solids and about ½ that used in Example #1.

The waste solids and EPS samples were blended together with some mixing movements of a flat stick in a holding cell.

The blend of materials was re-weighed to confirm blended density of about 49 grams.

The blended materials were placed on a paper towel and spread out over the surface for a 30 min retention time. After 30 min the amount of fluid drawn from the stabilized sample of materials was visually confirmed and show almost no fluid interaction with the paper towel.

### Example #3

Further testing was performed by combining about 1:1 volumes of centrifuge cuttings with newly formed, solid EPS beads (2-3 mm in diameter) to determine the uncut particles' ability to adsorb free oil in the sample.

This process did not prove as effective as the cut particle flake examples. Simple bead inclusion occurred wherein the beads appeared to be included in the cuttings sample without changing the cuttings viscosity. It was also observed that the volume increase of the combined material was much greater than when flakes were combined with centrifuge cuttings blend of Example #1.

### Example #4

The Paint Filter Liquids Test was used to study cuttings stabilization. The method is established by “9095B—1 Revision 2—November 2004 METHOD 9095B—PAINT FILTER LIQUIDS TEST”. Method 9095B is used to determine the presence of free liquids in a representative sample of waste and in summary, a predetermined amount of material is placed in a paint filter. If any portion of the material passes through and drops from the filter within the 5-min test period, the material is deemed to contain free liquids.

Method 9095B is as follows:
APPARATUS AND MATERIALS
Conical paint filter—Mesh number 60 +/−5% (fine meshed size).
Glass funnel—If the paint filter, with the waste, cannot sustain its weight on the ring stand, then a fluted glass funnel or glass funnel with a mouth large enough to allow at least 1 in. of the filter mesh to protrude should be used to support the filter. The funnel should be fluted or have a large open mouth in order to support the paint filter yet not interfere with the movement, to the graduated cylinder, of the liquid that passes through the filter mesh.
Ring stand and ring, or tripod.
Graduated cylinder or beaker—100-mL.
PROCEDURE
Place sample in the filter and support the filter with its conical bottom end aligned above the graduated cylinder. If a funnel is used to provide support for the paint filter. The funnel is supported with its spout opening into the graduated cylinder.
The sample is left to drain for 5 min into the graduated cylinder.
According to the prescribed method, if any portion of the test material collects in the graduated cylinder in the 5-min period, then the material is deemed to contain free liquids.

A 50 gram sample of waste solids that were separated from a hydrocarbon drilling fluid by centrifuge was obtained to an accuracy of +/−1.0 gram. <1 gram of EPS waste flakes were weighed and separated. These samples were blended together with some mixing movements of a flat stick in a holding cell.

The blend of the materials was tested using the above noted Paint Filter Liquids Test. The blended materials were placed in a paint filter set upon a filter stand over a graduated cylinder for a 5 min retention time.

The blended materials were visually examined and showed no free hydrocarbons upon completion of the Paint Filter Test. No liquids dripped from the filter.

### Example #5

Another Paint Filter Test was conducted with 100 grams of the hydrocarbon centrifuge cuttings alone with a 5 min residence time. Hydrocarbon liquid are noted in and on the filter and a drop of oil was expressed into the graduated cylinder. According to above-noted Method 9095B, this was a sample test failure.

### Example #6

Another sample of 88 grams of the same sample of hydrocarbon centrifuge cuttings as used in Example #5 was blended with less than 1.0 grams of EPS waste flake materials. The blend was placed in a paint filter for a 5 min residence time, using the prescribed Paint Filter Test method. No free oil was expressed from the blended sample into the cylinder.

### Example #7

A clean water sample was treated with a small sample of motor oil to simulate a water oil spill. A 5 w-30 motor oil was tested to show the natural oil water separation.

Two test vials were filled with fresh water and a small amount of motor oil. The oil was visible as a yellow slick on the surface of the water.

A small amount of white, fluffy, waste EPS flake was added to each vial. The EPS flake floated on the liquid. Visual confirmation showed that the motor oil was captured by the EPS flakes on the surface of the water.

The EPS flake and motor oil combined material formed a ball like mass on the surface of the water. After being skimmed from the water, the combined materials remained bound together as a more solid, yellow mass and generally clear water remained.

After the combined material was removed from the test vial, it was placed on a white paper towel. The paper towel adsorbed a yellow-ish liquid, concluded to be the oil and some water. Eventually, the flakes separated and dried up.

### Example #8

Starting with a volume of water weighing 40 g, 1 g EPS flake was added along with 5 g of SuperWet 250 surfactant. The EPS material captured the water and a white damp, clumped mixture was formed.

### Example #9

A sample of silicate water-based cuttings (100 grams) were treated by adding SuperWet 250 surfactant and EPS flakes. The resultant mixture was applied to white paper towel and very little liquid was observed to transfer to the paper towel.

### Example #10

A 100 g sample of high density brine cuttings was treated by adding SuperWet 250 surfactant and EPS flakes. The resultant mixture weighed about 100 g. The mixture was applied to white paper towel and very little liquid transferred to the paper towel.

Another 100 g sample of the high density brine cuttings was treated with a cellulose absorbent material. The volume of cellulose material was about the same as the volume of EPS flake used.

While the two resultant mixtures each appeared stabilized, there was a gain in mass of 30 g from the addition of cellulose compared to the EPS stabilized material, which had no measureable increase in mass.

### Example #11

High water content water-based drill cuttings produced from a SAGD drilling fluid was treated with EPS flakes. This cuttings waste contains rock cuttings in water with about 10% by volume hydrocarbon from the heavy oil formation. The mixed sample was spread on a paper towel and appeared granular and damp, but little liquid was transferred to the paper towel. It was concluded that the cuttings were stabilized by the EPS flake without the requirement for a wetting agent.

### Example #12

Further testing was done to show that the EPS flakes can be utilized to adsorb or clean up hydrocarbon spills from water. Due to the very low density of the EPS flakes any application of the material directly to land or water could be dispersed by environmental conditions such as wind forces. Testing was performed utilizing the EPS flakes contained in a sock formed of fine knit nylon. The netting mesh size was selected so as to prevent passage therethrough of the EPS flakes, but to permit passage of liquid. The filled sock weighed 9 grams. 50 grams of refined gear oil was added to a pan of water. The gear oil was visible as a yellow layer on the water. The sock was placed in the pan of water and oil. The flakes remained in the sock while absorbing the oil from the water. Due to the shallow depth of the water and oil, the sock was stationary in the pan. The water was occasionally moved to bring new water/oil into contact with the sock.

After a period of time, a large amount of the oil was captured into the sock as noted by the decrease in the yellow layer on the water. The sock was wringed and 75 grams of oil and water was obtained from the sock. The sock was then returned to the pan of water and it was observed that the amount of yellow oil floating on the water surface was further reduced as further oil was captured into the sock.

1. A method for capturing liquid waste from liquid waste-containing material, the method comprising:
combining expanded polystyrene particles with cut surfaces and the material, to thereby form a mixture wherein at least some of the liquid waste from the material is captured by the expanded polystyrene particles.

2. The method of claim 1 wherein the material is drill cuttings, and further comprising disposing of the mixture.

3. The method of claim 2 wherein the drill cuttings are water-based and combining includes adding a surfactant.

4. The method of claim 1 wherein the material is water containing oil and further comprising removing the expanded polystyrene particles from the water.

5. The method of claim 1 further comprising cutting the expanded polystyrene particles to form flakes.

6. The method of claim 1 wherein combining occurs at a worksite and further comprising shipping blocks of expanded polystyrene to a worksite and cutting the blocks to form the expanded polystyrene particles at the worksite.

7. The method of claim 1 further comprising removing the expanded polystyrene particles from the mixture and processing the expanded polystyrene particles to remove the liquid hydrocarbon and to obtain recovered expanded polystyrene particles.

8. The method of claim 7 further comprising combining the recovered expanded polystyrene particles with further liquid hydrocarbon-containing material.

9. Expanded polystyrene particles for use as a capturing material to capture liquid waste from an environment, a majority of the expanded polystyrene particles comprising: cut surfaces with at least some exposed, opened air bubbles.

10. Expanded polystyrene particles of claim 9 joined together for shipping.

11. Expanded polystyrene particles of claim 9 wherein the particles are used while they remain contained in a liquid penetrable container and the liquid waste is captured within the container.

12. Landfill-ready liquid-waste-contaminated material comprising: expanded polystyrene (EPS) particles having cut surfaces to expose opened bubbles, wherein a liquid waste from the material is captured by the expanded polystyrene particles.

13. The landfill-ready material of claim 12 wherein the landfill-ready material is waste material from an oil well site.

14. The landfill-ready material of claim 13 wherein the waste material is drill fluid cuttings; and liquid waste from the drill fluid cuttings is adsorbed to the cut surfaces.

15. The landfill-ready material of claim 14 wherein the liquid waste is hydrocarbon-based drilling fluid or oil/water emulsion drilling fluid.

16. The landfill-ready material of claim 14 wherein the liquid waste is water-based drilling fluid and the landfill-ready material further comprises a surfactant additive.

17. The landfill-ready material of claim 12 wherein the material passes a Paint Filter Liquids Test.
